(19) United States
(12) Patent Application Publication
(10) Pub. No.: US 2005/0154734 A1
(43) Pub. Date: Jul. 14, 2005

(54) Method and system for monitoring and reporting backup results

(75) Inventor: Stephane Zucchini, Nice (FR)

Correspondence Address: IBM CORPORATION, IPLAW IQ0A/40-3, 1701 NORTH STREET, ENDICOTT, NY, 13760, US

(73) Assignee: INTERNATIONAL BUSINESS MACHINES CORPORATION, ARMONK, NY (US)

(21) Appl. No.: 11/015,168

(22) Filed: Dec. 17, 2004

(30) Foreign Application Priority Data
Dec. 19, 2003 (EP) 03368125.5

(51) Int. Cl. G06F 7/00

(52) U.S. Cl. 707/10

(57) ABSTRACT

A method and system for monitoring and reporting backup results, comprising a plurality of customer servers under the control of an administrator, through a data transmission network, is disclosed. The customer servers have data which are to be saved at predefined times by running backup jobs, with the execution of each backup job resulting in a result report which is monitored by the administrator. The system comprises a backup reporting server connected to the data transmission network and to which all result reports are forwarded from the plurality of customer servers. The backup reporting server includes a system for building a table of the results which can be read by the administrator.

### FIELD OF THE INVENTION

The present invention relates to analyzing server backup results for a plurality of servers having backups regularly performed by an administrator in charge of these servers, and in particular relates to a system of backup result monitoring and reporting.

### BACKGROUND OF THE INVENTION

In a contemporary business environment, it is a common practice for owners of data processing systems to contract for the administration of these systems with a company such as IBM, in an arrangement that is frequently referred to as outsourcing. (IBM is a Registered Trademark of International Business Machines Corporation.) The data processing systems, which are generally servers, may be located at the premises of the company providing the administration. Such servers may be power servers, application servers, file servers, database servers, print servers, web servers, or any other type of servers.

Along with other services provided in such an outsourcing arrangement, a service provider has to regularly save data residing on the customer servers so that these data can be recovered in case of a system crash or other type of system failure. This saving action is generally referred to as a backup job, and is implemented as an executable procedure, such as a script or program being started on the customer server, either manually by an administrator, or automatically by a scheduler program. Backup jobs are typically run overnight so as to not impact server workload during the day.

When a customer signs with an administration provider to set up an outsourcing contract, the provider generally uses backup programs installed and used by the customer. This may result in the provider having to manage a wide variety of backup programs running on many different servers. Each backup program may have a unique format, messaging, and reason codes. The output messages are, or can be directed to, dedicated or predefined files called backup logs. Therefore, an analysis of the backup logs has to be conducted very carefully so as to accurately determine backup results.

The administrator in charge of the backup jobs must review the backup results to ensure data backup integrity, and also to report backup results to the customers. Generally, a log file is generated by the scheduler program and the backup program, during and at the end of the backup job. The administrator has to analyze this log file to determine a status for the backup results. Given that such an analysis is generally performed in the morning of a workday, immediate reaction to a problem is not generally required as usually nothing further needs to be done before the next backup job is scheduled.

A solution used by IBM to check backup results comprises using the IBM Tivoli Storage Manager (hereinafter referred to as “ITSM”) which is a program able to schedule backup jobs and scripts, and to provide a backup completion or reason code by querying an ITSM server. (Tivoli is a Trademark of International Business Machines Corporation.) The backup results are centrally stored in an ITSM server database. Therefore, an ITSM administrator can consult the database and generate backup reports. However, this solution has limitations, as from time to time, backup result information does not reach the ITSM server, and the information is therefore not available. Furthermore, this manner of receiving backup results is restricted to an ITSM environment, such that the backup results are not available outside of an ITSM cell and therefore, not available to a customer representative.

### OBJECTS AND SUMMARY OF THE INVENTION

It is an object of the present invention to provide a system enabling an administrator in charge of backup jobs to analyze, on a regular basis, backup result reports resulting from backup jobs performed with regard to customer servers.

In accordance with one embodiment of the present invention, there is provided a system for server backup result reporting and monitoring, comprising a plurality of customer servers under administrative control of an administrator by utilizing a data transmission network, wherein the customer servers each contain data to be saved at predefined times by running one or more backup jobs, and wherein execution of each backup job results in a result report which is monitored by the administrator, and a backup reporting server connected to the data transmission network, wherein the result report of each backup job is forwarded to the backup reporting server, and wherein the backup reporting server includes means for building a table of the backup job results which can be read by the administrator.

In accordance with another embodiment of the present invention, there is provided a method for backup result reporting monitoring of customer host scheduled backup operations in a system comprising at least one customer host, an administration platform connected to an administration server, and a system management platform receiving alerts from managed systems, the method comprising recording on the administration platform information about a customer host backup operation in a customer database, and a key encoding customer host backup operation scheduling data, sending from the administration platform a parameter file containing the customer host backup operation information to the at least one customer host, starting, upon triggering by a customer host scheduler, the customer host backup operation by reading host backup commands in the parameter file and generating the host backup commands, reading a format of a host backup log file in the parameter file and reading a backup result in the host backup log file, sending an alert containing the parameter file and the backup operation result to the system management platform, storing the customer host backup operation result in a historical database, reading expected host backup operation results from a customer database and comparing the expected results with each customer host backup operation result received at the system management platform so as to identify any missing host backup operation results, and starting one or more reporting applications regarding customer host backup operation results from the administration server.

### BRIEF DESCRIPTION OF THE DRAWINGS

The above and other objects, features, and advantages of the invention will be better understood by reading the following more particular description of the invention in conjunction with the accompanying drawings, wherein:

FIG. 1 is a diagram depicting a system of backup result monitoring and reporting in accordance with one embodiment of the present invention.

FIGS. 2A and 2B depict examples of a menu system provided by a backup reporting server for a backup job in accordance with one embodiment of the present invention.

FIG. 3 is a flow diagram of a scheduler program in accordance with one embodiment of the present invention.

FIG. 4 depicts a scheduling key encoding backup scheduling data for a customer backup operation in accordance with one embodiment of the present invention.

FIG. 5 is a flow diagram of a backup method in accordance with one embodiment of the present invention.

### BEST MODE FOR CARRYING OUT THE INVENTION

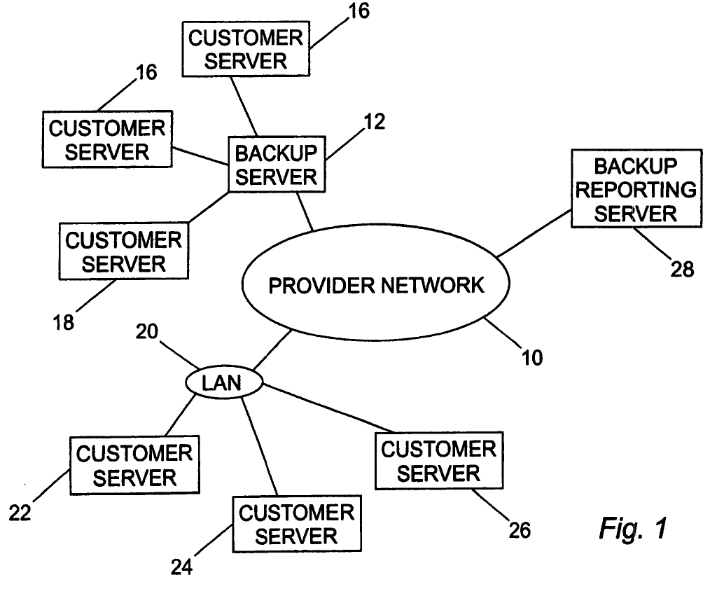

In accordance with the present invention as depicted in FIG. 1, a plurality of customer servers 14, 16, 18 are connected to provider network 10, in one example a Virtual Private Network, either at a provider premises by utilizing backup server 12, or at a customer premises by utilizing Local Area Network (hereinafter referred to as “LAN”) 20 to connect to customer servers 22, 24, 26. It should be noted that it does not matter whether the customer servers are located at the premises of the provider or not. In any event, the provider has backup reporting server 28 available which is also connected to network 10.

Each customer server is associated with a backup job which is contained in a Backup Command Manager (hereinafter referred to as “BCM”) which is a script designed to execute actions identified across a standard backup process. The backup job for each server uses parameters from a file called BCM_name, which includes data such as:
customer identification
name of machine
backup program
backup type
BCM description
scheduling key

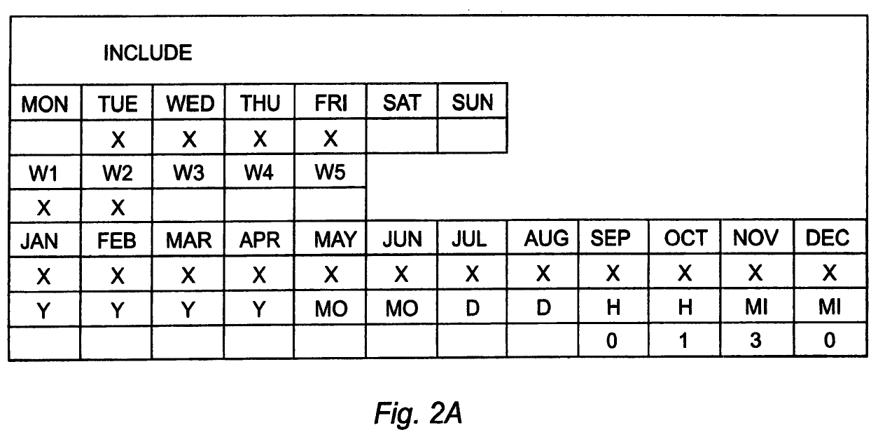

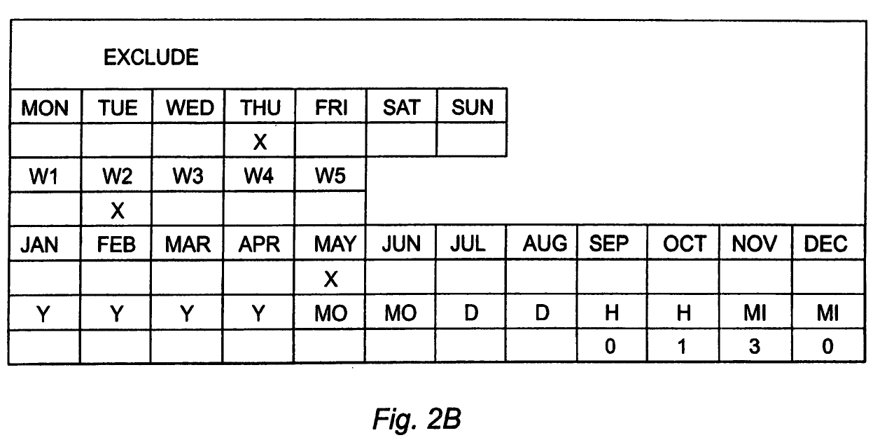

An administrator registers a customer and BCM_name with backup reporting server 28 and installs BCM and Backup Status Analyzer (hereinafter referred to as “BSA”) programs, as well as a BCM_name file in each customer server. The registration procedure further comprises the administrator providing a corresponding scheduling definition utilizing a backup menu system which is designed to allow specification of the dates when the backup job (BCM_name) should run, as well as how many times the backup job should run within a defined period. An example of such a menu system is depicted in FIGS. 2A and 2B. FIG. 2A depicts an INCLUDE menu which comprises cases associated with the days in a week, the weeks in a month, and the months in a year. The INCLUDE menu further comprises cases for a date, and for the time of day.

Several cases are marked with an “X” in the example depicted in FIG. 2A so as to define when a backup job should be executed. Specifically, the cases associated with Tuesday, Wednesday, Thursday, and Friday are marked, along with weeks W1 W2, as well as the 12 months of the year, meaning that in this example, a backup job is to be executed each Tuesday, Wednesday, Thursday, and Friday of the first two weeks of each month. Furthermore, the time of execution for starting the backup job is defined as being at 01 hour 30 minutes in this example, as shown in the menu by the numerals 0, 1, 3, and 0.

In addition to selecting days, weeks, and months of the year, it is also possible to define a date when a backup job is to be executed. This means that a backup job will be executed on this date. A menu where just a date is defined will be valid only one time, and a new menu has to be completed each time a backup job is to be executed. In contrast, the menu definition described hereinabove where days, weeks, and months of the year are selected may stay the same, and be valid, during the course of a given year.

An EXCLUDE menu is depicted in FIG. 2B which comprises substantially the same cases depicted in the INCLUDE menu of FIG. 2A. However, in the EXCLUDE menu, the cases which are marked with an “X” define days which are excluded for the execution of a backup job, even though these days were selected utilizing the INCLUDE menu. Thus, in FIG. 2B, the selected cases are THU, W2, and MAY, which means that a backup job will not be executed on Thursday of the second week of May.

The information which has been entered into the menu system, as described hereinabove, constitutes a REFERENCE for a customer server, and is recorded by backup reporting server 28. At substantially the same time, the information that was entered into the menu system is converted into a scheduling key which is forwarded to the customer server and incorporated into the BCM_name file. Using data in the BCM_name file, the BCM executes a backup job at the time(s) and date(s) which have been defined in the scheduling key.

After execution of a backup job, a backup job LOG is analyzed by the BSA, which is a versatile script specific to each backup program (e.g. ITSM, VERITAS, MKSYSB, BACKUP, etc.) used in the BCM. The BSA then returns a global backup job result for reporting purposes. This result is sent from a customer server to backup reporting server 28 to allow recording in a result table. Thus, an administrator may periodically compare the information recorded in the result table with the REFERENCE for each customer server, and may generate a report if there has been a problem with the execution of a backup job.

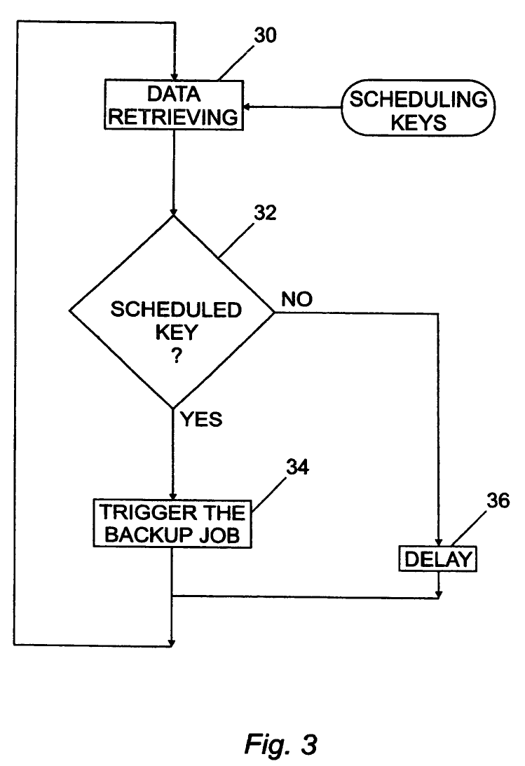

In accordance with one embodiment of the invention, it is possible to run a scheduler program at backup reporting server 28 so as to trigger a backup job execution at each customer server. Such a scheduler program, which is depicted in FIG. 3, starts by retrieving the data of each REFERENCE associated with a backup job in step 30. As described hereinabove, the data in each REFERENCE is that which was used to define a corresponding scheduling key. In step 32, a check is performed as to whether there is a scheduling key. If so, a backup job execution is triggered at the associated customer server by the BCM in step 34. If there is not a scheduling key, a delay is performed in step 36. Such a delay, in one example 5 seconds, is used to avoid the scheduler program looping continuously without triggering a backup job. It should be noted that a scheduler program similar to that which is shown in FIG. 3 can be run at each customer server. In such a case, the data retrieved in step 30 corresponds only to any scheduling keys which have been defined for that customer server.

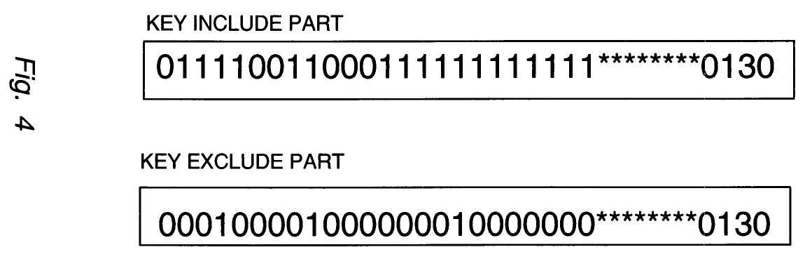

FIG. 4 depicts coding of a scheduling key corresponding to an entry of scheduling data pertaining to a backup operation on a customer server, also known as a customer host, as shown in FIGS. 2A and 2B. One advantage of a scheduling key is to have, in an abbreviated and efficient format, a summary of scheduling of a backup operation for a given customer host. This efficient format allows the information in a scheduling key to be stored or sent over a network, if necessary, in a cost effective manner. This format further allows generalized and efficient analysis of a Backup Status Report (hereinafter referred to as “BSR”) file. A scheduling key comprises two parts: an include part and an exclude part. For both of these parts, days of the week, week of the month, and months of the year may be coded with bits, “1” for “yes”, and “0” for “no”. In one embodiment, date and time may be coded with decimal numbers, or a meta-character (e.g. n) may be used if any value is valid.

A scheduling key representing backup scheduling data of a backup operation may be used by a BSR analyzer, operating on an administration platform, which compares the backup operation result received for a period of time with backup scheduling data that was expected for this period of time. By reading a scheduling key, the analyzer can immediately determine if a backup operation was expected.

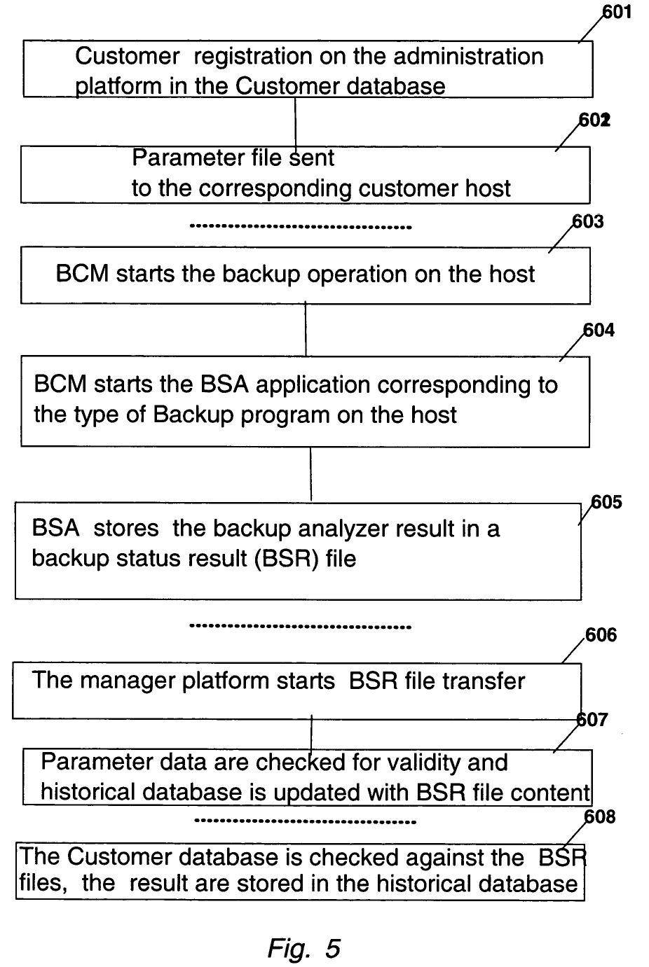

A scheduling key, which is computed on an administration platform server, is included in a parameter file which is sent to one or more customer hosts as described in FIG. 5. This parameter file is transferred back along with the BSR file from each customer host to the administration platform server, and in one embodiment of the present invention, is used for checking the validity of data in this transfer. It should be noted that the ability to verify the validity of the data in this transfer provides an advantage with respect to monitoring backup results of customer host systems according to the present invention.

Further, a scheduling key, once sent from an administration platform server to a customer host, may be used on the customer host if a scheduler other than a standard scheduler of a host operating system is used to schedule backup operations. In accordance with one embodiment of the present invention, an instance of the BCM application performs backup operations on a customer host, and includes a specific scheduler. However, in an alternate embodiment, an instance of the BCM may be triggered to perform the backup operation by a scheduler of a host operating system. In this embodiment, a scheduling key is not used as scheduling data for backup operations are entered in a manner prescribed by a host operating system scheduler.

An administration platform is connected to an administration server used for centralized backup result monitoring and reporting operations. For each backup operation, the administration platform initiates two processes: a customer backup operation registration, and a validity check of BSR files received from customer hosts that contain backup operation results. The administration platform also initiates a periodic backup result analysis.

A backup system operation manager platform, which is connected to a different server than the administration platform server, initiates the transfer of BSR files containing backup operation results from customer hosts to the administration platform server. It should be noted that this function can be provided by the administration platform server, however for security reasons, it is advantageous to have this function provided by the backup system operation manager platform.

The functions described hereinabove provide for backup result reporting. According to one embodiment of the present invention, a system management platform which is accessible using provider network 10, and which receives alerts, is provided. Alerts are sent to the system management platform by one or more customer hosts subsequent to a pre-determined end of backup operation being detected, which provides for on-line monitoring of backup operation results.

According to one embodiment of the present invention, a backup program is installed on each customer host for performing backup operations. An operating system installed on a customer host may have a scheduler to start backup operations on the respective host. However, scheduling data will need to be entered to define starting times of backup operations should a customer host scheduler be utilized to initiate host backup operations.

According to one embodiment of the present invention, a backup monitoring program, the BCM, is installed on each customer host. A specific scheduler may be included with the BCM which, using scheduling data in a scheduling key, initiates backup operations on a customer host. In an alternate embodiment, a customer host scheduler may start the BCM, which in turn starts backup operations on the host by initiating commands of a host backup program. The BCM reads a backup parameter file in which a type of backup program and a backup log file name for a given backup operation are identified. The BSA program comprises BSA sub-functions for backup result analysis. A BSA sub-function which is executed by the BCM after execution of a backup operation is adapted to locate a backup log file of a customer host backup program, and to read backup result information therefrom.

A flow diagram of a method according to one embodiment of the present invention is shown in FIG. 5. In step 601, customer registration occurs when information regarding a customer backup operation is entered into a customer database at an administration platform. The information may include a name and id of a customer, a host name, backup scheduling data which are entered through at least one graphical user interface (depicted in FIGS. 2A and 2B) which are then stored as an encoded scheduling key (depicted in FIG. 4), a host backup program type, and a host backup log file. The same customer may enter information regarding more than one backup operation operating on one or more customer hosts.

A parameter file comprising the information described hereinabove regarding a backup operation is created and sent to a corresponding customer host in step 602. Only some of the information contained in the parameter file is used at the customer host, however all of the information is sent to the customer host, as this information will be returned subsequent to backup execution in a file containing a backup execution result for identification purposes. It should be noted that identification and verification of backup result validity are not absolutely essential for operation of the present invention. However, maximizing security when managing backup operations on systems and providing reports is advantageous.

A backup operation is started on the customer host after steps 601 and 602 are performed. In FIG. 5, a dotted line between two steps means that the sequence of steps is as depicted, however a subsequent step, which is executed after completion of a first step, may be started after a certain time delay. The BCM program, which is installed on the customer host according to one embodiment of the present invention, initiates a backup operation at a scheduled time in step 603. The BCM reads a backup program type to be executed from the parameter file received from an administration server. Upon request of a scheduler, the BCM initiates a host backup program. In one embodiment of the present invention, a scheduler is included in the BCM, which reads and uses a scheduling key in the parameter file to start a host backup program.

A backup execution has a final return code which is zero only if the backup completes without any errors. If the backup is completed, the BCM identifies a backup log file and backup program type by examining the parameter file. The BCM initiates execution of a BSA program corresponding to the backup log file and backup program type in step 604. The result of the analysis provided by execution of the BSA is a set of values, also used by other BSA program instances, comprising: OK, not OK, OK with error code, according to one embodiment of the present invention. Upon completion of BSA execution, an alert message containing backup operation information (read from the parameter file) and results can be sent to a systems management platform for monitoring purposes. Dynamically monitoring backup operation results provides an ability to execute corresponding systems management procedures, if necessary. The result of the backup operation, as well as information read from the parameter file are written in a BSR file on a customer host in step 605. It should be noted that the format and interpretation of a BSR file are substantially the same, irrespective of customer host or backup operation having been executed.

In step 606, a backup manager platform initiates a transfer of a BSR file to a centralized backup monitoring and reporting server. This operation can be automatically started, for example each evening, each week, or each month and performed for all BSR files on customer host systems which are ready to be sent. According to one embodiment of the present invention, step 606 is performed utilizing a backup manager platform connected to a different server than the administration platform server for security reasons.

Upon receipt of a BSR file, an administration platform checks for validity of BSR file content by comparing the content against corresponding content in a customer database in step 607. The BSR file is ignored if an accompanying parameter file does not correspond to a valid customer database entry. However, if the validity is verified, backup operation results from the BSR file are stored in a customer backup historical database. It should be noted that the customer database and the historical database may be implemented as two tables in the same database.

In step 608, an analysis of the customer database is initiated to identify backup operations which were expected to have been completed, but for which a BSR file has not been received. In such a situation, a result of “backup missing” is written in the historical database. Identification of an expected backup operation is performed by reading a scheduling key for each customer backup operation in the customer database so as to identify if a given backup operation should have been completed by the current time of day. Computation of “backup missing” results is performed every night according to one embodiment of the present invention. Once the historical database is updated, a backup result report can be issued from an administration server, which is a daily report according to one embodiment of the present invention. In one example, results which will be reported for backup operations scheduled for a given day are “backup missing”, “OK”, “not OK”, and “OK with return code XX”. An application performing conformity checking with a Service Level Agreement (hereinafter referred to as “SLA”) with customers may be implemented by reading content in the historical database created by a method according to one embodiment of the present invention. Monitoring alerts, report applications, and SLA conformity applications may be standardized for all of the customer hosts.

1. A system for server backup result reporting and monitoring, comprising:
a plurality of customer servers under administrative control of an administrator by utilizing a data transmission network, wherein the customer servers each contain data to be saved at predefined times by running one or more backup jobs, and wherein execution of each backup job results in a result report which is monitored by the administrator; and
a backup reporting server connected to the data transmission network, wherein the result report of each backup job, is forwarded to the backup reporting server, and wherein the backup reporting server includes means for building a table of the backup job results which can be read by the administrator.

2. The system of claim 1, wherein at least one customer server of the plurality of customer servers are located at premises of a provider in charge of the customer servers, and wherein the customer servers are connected to a provider network utilizing a backup server.

3. The system of claim 1, wherein each backup job of the one or more backup jobs is contained in a backup command manager (BCM) associated with each server of the plurality of customer servers, wherein the BCM is a versatile script for executing actions identified across a backup process.

4. The system of claim 3, wherein each backup job of the one or more backup jobs utilizes a BCM_name file containing parameters to execute the backup job.

5. The system of claim 4, wherein a backup status analyzer (BSA) is associated with the BCM of each server of the plurality of customer servers, and wherein the BSA is a versatile script adapted to analyze a backup job log and return a backup job result to the backup reporting server.

6. The system of claim 5, wherein a scheduling key is defined at the backup reporting server for each server of the plurality of customer servers by providing data in a backup menu system regarding dates and time to start a backup job at each customer server.

7. The system of claim 6, wherein the backup menu system comprises an INCLUDE menu adapted to define days of the week, weeks of the months, months of the year, a specific date or a generic date coded with a meta-character, so as to define one or more days on which a backup job is to be executed.

8. The system of claim 7, wherein the INCLUDE menu is further adapted to define a time at which a backup job is to be executed.

9. The system of claim 8, wherein the backup menu system further comprises an EXCLUDE menu adapted to define one or more days, weeks, and/or months defined in the INCLUDE menu which are to be excluded for executing a backup job.

10. The system of claim 9, wherein the backup reporting server further comprises a scheduler program for triggering a backup job at each customer server by utilizing information in the scheduling key, wherein the information in the scheduling key is defined by utilizing the backup menu system.

11. The system of claim 6, wherein the scheduling key is defined based upon data entered into the backup menu system, wherein the backup menu system comprises an INCLUDE menu encoding an INCLUDE part of the scheduling key and an EXCLUDE menu encoding an EXCLUDE part of the scheduling key, and wherein both the INCLUDE and EXCLUDE parts of the scheduling key comprise seven bits identifying when set to 1, the scheduling of one day of the week, followed by five bits identifying when set to 1, the scheduling of one week of the month, and twelve bits identifying when set to 1, the scheduling of one month of the year.

12. The system of claim 11, wherein both the INCLUDE and EXCLUDE parts of the scheduling key further comprise four decimal characters for a year, two decimal characters for a month of the year, two decimal characters for a day of the month, two decimal characters for an hour of the day, and two decimal characters for minutes of the hour.

13. A method for backup result reporting and monitoring of customer host scheduled backup operations in a system comprising at least one customer host, an administration platform connected to an administration server, and a system management platform receiving alerts from managed systems, the method comprising:
recording on the administration platform information about a customer host backup operation in a customer database, and a key encoding customer host backup operation scheduling data;
sending from the administration platform a parameter file containing the customer host backup operation information to the at least one customer host;
starting, upon triggering by a customer host scheduler, the customer host backup operation by reading host backup commands in the parameter file and generating the host backup commands;
reading a format of a host backup log file in the parameter file and reading a backup result in the host backup log file;
sending an alert containing the parameter file and the backup operation result to the system management platform;
storing the customer host backup operation result in a historical database;
reading expected host backup operation results from a customer database and comparing the expected results with each customer host backup operation result received at the system management platform so as to identify any missing host backup operation results; and
starting one or more reporting applications regarding customer host backup operation results from the administration server.
